(19) United States
(12) Patent Application Publication
(10) Pub. No.: US 2007/0019425 A1
(43) Pub. Date: Jan. 25, 2007

(54) Daylight emitting panel

(75) Inventors: Edwin P.H. Van Lier, Eindhoven (NL); Augustinus Gregorius Henricus Meijers, Eindhoven (NL); Wolfgang Mueller, Wermelskirchen (DE); Johan Vissers, Etten-Leur (NL); Robin Ndagijimana, Neuss (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/570,869

(22) PCT Filed: Sep. 7, 2004
(86) PCT No.: PCT/IB04/51704

§ 371 Date: Mar. 7, 2006

(30) Foreign Application Priority Data
Sep. 8, 2003 (EP) 03077816.1

(51) Int. Cl. B60Q 1/26; F21V 7/04

(52) U.S. Cl. 362/493; 362/621

(57) ABSTRACT

The invention relates to a light emitting panel (1) to be mounted against the roof of the passenger compartment of a vehicle, comprising a transparent plate-like light guiding member (2) whereby light is coupled in through one or more side surfaces (21) of the member (2) and light is coupled out through the lower surface(22) of the member (2) for lighting said compartment. According to the invention a light transmitting cover (200) is attached to said lower surface (22) of the member (2).

The invention relates to a light emitting panel to be mounted as a roof element of a passenger compartment of a vehicle, comprising a transparent plate-like light guiding member whereby light is coupled in through one or more side surfaces of the member and light is coupled out through the lower surface of the member for lighting said compartment.

A light emitting panel of the kind mentioned in the pre-amble has been proposed in the past. In this way a large area illumination of the headroom of the vehicle passengers is achieved, which will provide for an idea of space. The known solution has as a drawback that the light emitting panel forms a relative large area which has a non-compatible outer surface in relation to the vehicle interior.

It is an object of the invention to provide for a light emitting panel which overcomes the mentioned drawbacks.

A light emitting panel as mentioned in the preamble is according to the invention characterized in that a light transmitting cover is attached to the said lower side of the panel. In a very advantageous and simple way it is achieved that the light emitting panel is provided with an outer surface which can be fully compatible with the vehicle interior. In a preferred embodiment the light transmitting cover is translucent textile. As interiors of transport vehicules, particular motor cars, are generally provided with textile as upholstery the forming of a compatible outer surface of the light emitting panel is further promoted.

Preferably the translucent textile cover is attached to the lower side of the light guiding member by means of glue having a lower index of refraction than the material of the light guiding member. Thus the glue has no optical contact with the emitting panel. In simple and reliable way covering of the light emitting panel is realized whitout uncontrolled out coupling of light because the lower index of refraction prohibits the the glue to stimulate outcoupling of light. Alternatively the textile cover is attached to the lower side by glue, which is applied locally in a predetermined pattern. In the circumstance of light outcoupling due to the glue having a relative high refraction index or etching the light guiding member, the process is thus controlled. The outcoupling of light due to glue having optical contact with the light emitting panel is best controlled if the glue is applied on less than 10% of the lower side of the emitting member, preferably less than 5%. Thus a relative small amount of light will be outcoupled due to the glue, whilst the textile cover will be attached sufficiently firm to whist and normal burden of day to day use of the vehicle.

The above described and further aspects of the invention will be elucidated by a drawing in which

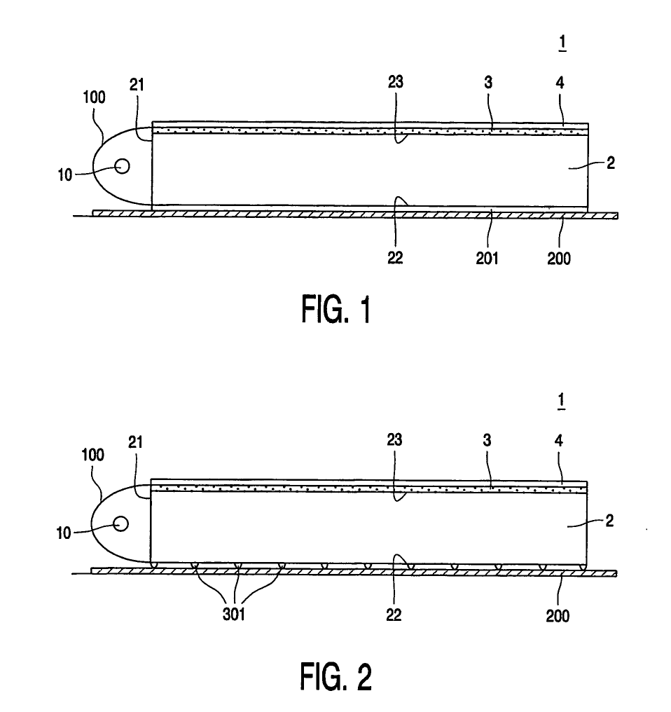

FIG. 1 is a side elevation of a light emitting panel acording to the invention, and

FIG. 2 an alternative embodiment of the light emitting panel.

The Figures, which are schematic are indicative only for the construction of the light emitting panel and are not to scale. Corresponding features in the Figures have been given the same reference sign.

In FIG. 1 a side elevation of a light emitting panel 1 according to the invention is depicted. The panel comprises a transparent plate-like light guiding member 2. Suitable materials for the light guiding member are PMMA (poly methyl methacrylate), poly carbonate and glass. To counteract uncontrolled light outcoupling the light guiding member may be provided with a cladding, either on one or on both sides, the cladding having an index of refraction lower than the index of the light guiding member, for example magnesium- or calcium-fluoride with an index of refraction of 1.390 respectively 1.434. Light is coupled in by a light source 10 with a reflector body 100 through a side surface 21. Light is coupled out through a lower surface 22 of the member for lighting a compartment. A light transmitting cover 200 is attached to the lower surface by means of a glue 201, alternatively adhesive-tape may be used for this purpose. In the shown embodiment the glue covers substantially the lower surface. Preferably the thus provided, non-etching glue has a lower index of refraction than the material of the light guiding member, thus avoiding disturbance of the total internal reflection of the light guiding member.

An upper side 23 of the light guiding member 2 is provided with a structure 3, in this embodiment a pattern of dots, which disturbes the total internal reflection of the light inside the guiding member and thus providing for light outcoupling. The structure may be applied just below the surface in the bulk, for example by means of a laser, or at the surface, for example by means of a laser or via etching. Alternatively the mechanism disturbing the total internal reflection can be formed by an internal structured layer, for instance a foam inside the light guiding member. To counteract light outcoupling after scattering in upward directions the structure 3 is covered by a reflector 4, for instance a reflective laquer, a (white) paint, foil or film for example highly reflective aluminum (for example VM2000 make 3M or Alanol Miro).

In an alternative embodiment shown in FIG. 2 the glue is only locally applied in a predetemined pattern 301 on the light guiding member.

In a practical embodiment the light transmitting cover is formed by a textile. The textile, which is essentially transparent can be either woven or non woven.

In the practical embodiment the light guiding member is made of PMMA with an index of refraction of 1.489, the total internal reflection disturbing structure 3 is formed by a dot pattern at the upper surface and the reflector is a foil of a diffuse reflective layer Torray E60L. In this embodiment the reflector is attached to the light guiding member 2 via FEP-C-tape which has a respective index of refraction of its teflon carrier of 1.338 and of its silicone adhesive of 1.40.

Further, suitable types of glue are for instance silicone-, acrylate- and polyurethane-glues.

1. A light emitting panel to be mounted as roof element of a passenger compartment of a vehicle, comprising a transparent plate-like light guiding member whereby light is coupled in through one or more side surfaces of the member and light is coupled out through the lower surface of the member for lighting said compartment, characterized in that a light transmitting cover is attached to said lower surface of the member.

2. A light emitting panel as claimed in claim 1, characterized in that the light transmitting cover is translucent textile.

3. A light emitting panel as claimed in claim 2, characterized in that said textile is attached to said lower side by means of glue having a lower index of refraction than the material of said member.

4. A light emitting panel as claimed in claim 2, characterized in that said textile is attached to said lower side by means of glue making optical contact with said member, whereby said glue is locally applied in a predetermined pattern.

5. A light emitting panel as claimed in claim 4, characterized in that said glue is applied on less than 10% of the lower side of said member, preferably less than 5%.

6. A light emitting panel as claimed in claim 1, characterized in that a reflector 4 is attached to the upper side 23 of the member 2.

7. A light emitting panel as claimed in claim 6, characterized in that said reflector 4 is attached to said upper side 23 by means of an adhesive tape-, glue-, or weld-structure.
